(19) United States
(12) Patent Application Publication
(10) Pub. No.: US 2008/0233511 A1
(43) Pub. Date: Sep. 25, 2008

(54) TONER, AND IMAGE FORMING APPARATUS AND PROCESS CARTRIDGE USING THE SAME

(76) Inventors: Yoshimichi ISHIKAWA, Itami-shi (JP); Chiyoshi Nozaki, Otsu-shi (JP); Tsuyoshi Nozaki, Ikeda-shi (JP); Takuya Kadota, Kobe-shi (JP); Hiroyuki Murakami, Toyonaka-shi (JP); Mitsuyo Matsumoto, Ibaraki-shi (JP); Atsushi Yamamoto, Kawanishi-shi (JP); Katsunori Kurose, Takarazuka-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/050,963

(22) Filed: Mar. 19, 2008

(30) Foreign Application Priority Data
Mar. 19, 2007 (JP) 2007-071438

(51) Int. Cl. G03G 9/00; G03G 15/20

(52) U.S. Cl. 430/112; 399/308

(57) ABSTRACT

A toner including particles including a toner composition including a binder resin and a coloring material, wherein the toner composition includes a laminate compound A in which a cation between layers is modified by an organic cation, and a laminate compound B in which an anion between layers is modified by an organic anion, the laminate compound A is of negative charging property upon particulation of the laminate compound A by dispersion or internal addition in the binder resin and the laminate compound B is of positive charging property upon particulation of the laminate compound B by dispersion or internal addition in the binder resin, and the toner is of a positive charging property.

### BACKGROUND OF THE INVENTION

1. Field of the Invention

The present invention relates to a toner and an image forming apparatus, and a process cartridge using the toner.

2. Discussion of the Background

As a toner fixing system, a contact heating fixing system such as a heat roll fixing system has been widely adopted. A fixing device for use in such a heat roll fixing system includes a heat roll and a pressure roll and fixes a toner image on a recording medium by fusing the toner image upon application of heat and pressure when the recording medium passes through the heat roll and the pressure roll.

In the contact heating fixing system represented by a heat roll fixing system, a toner image on a recording medium is fixed by contacting the surface of a heating member (for example, a heating roll) provided to a contact heating type fixing device. Upon fixing, part of the toner image is attached to the heating member, which may be transferred to the following recording media and causes contamination on the image thereon. This is called offset, which should be prevented.

To prevent this offset phenomena, there is known a technology in which a fixing oil such as silicon oil is applied to or impregnated in a heat roll and/or a pressure roll in a fixing device. In light of the size reduction of a fixing device and cost reduction, a fixing device by which no or a small amount of oil is applied is adopted. When such a fixing device is adopted, a releasing agent is added to toner as an offset inhibitor.

In addition, in the case of a heating fixing system, it is preferred that the fixing temperature is as low as possible in terms of energy saving. However, thermal characteristics of the binder resin contained in a toner, which are designed to make the fixing temperature as low as possible, trade off high temperature preservability of the toner, which causes problems such as blocking. To have a good combination of lowering the fixing temperature range and the high temperature preservability of a toner, it is advantageous to use a polyester reins as the binder resin. Polyester resins have relatively low viscosity and high elasticity in comparison with vinyl based copolymer resins so that the low temperature fixing property and the high temperature preservability of polyester resins are excellent.

However, when a toner to which an ample amount of releasing agent is added to prevent offset phenomenon is manufactured by a typical pulverization method, the releasing agent exposes to the surface of the toner particles excessively, which causes problems such as filming and blocking.

Also, there are known polymerization methods such as a suspension polymerization method in which a polymerizable monomer is polymerized in an aqueous medium and an emulsification polymerization method in which particulates are preliminarily manufactured by emulsification polymerization and agglomerated. Toners manufactured by a polymerization method can contain more releasing agents in comparison with toners manufactured by a pulverization method.

As a technology with regard to toner manufacturing by a suspension polymerization method, for example, Japanese patent No. (hereinafter referred to as JP) 3195362 describes controlling a toner structure by sequentially adding a polymerizable monomer for polymerization after normal granulation is complete.

In addition, as a technology with regard to toner manufacturing by an emulsification polymerization method, for example, unexamined published Japanese patent application No. (hereinafter referred to as JOP) 2002-116574 describes controlling a toner structure by sequentially adding emulsified particulates for polymerization after normal granulation is complete.

However, in the suspension polymerization method and the emulsification agglomeration method, a vinyl based copolymer resin is used to conduct polymerization reaction in an aqueous medium. Therefore, it is difficult to use a polyester resin which can be polymerized at a high temperature, for example, around 200° C.

In addition, as a method of granulating a toner using a polyester resin, a dissolution suspension method is known in which a preliminarily polymerized resin is dissolved in an organic solvent followed by granulation in an aqueous medium.

In this method, the molecular weight of a resin before granulation is the molecular weight of the obtained toner. That is, it is typical to mix a resin having a low molecular weight and a polymer resin for adjusting thermal characteristics of a toner. However, a polymer resin makes the viscosity of a solution excessively high, which causes a problem such as deterioration of granulation property. Therefore, it is preferred to avoid using a polymer resin in a large amount. Consequently, it is inevitable that the molecular weight of a resin having a low molecular weight is adjusted to be relatively high, which is disadvantageous in light of the low temperature fixing property.

To solve this problem, there is a method in which, instead of placing a polymer resin from the first, a modified polyester resin having a reaction group is mixed and the molecular weight is controlled by conducting elongation and/or cross-linking reaction after granulation. In this method, it is possible to adjust thermal characteristics of a toner but this is not sufficient to control the toner structure. Thus, a coloring agent and a releasing agent tend to expose to the surface of toner particles. Especially, in the case of a one-component developing agent (toner), the charging property is insufficient so that the background fouling occurs when such a toner is continuously used.

When a toner has a low charging ability, a charge control agent can be added. However, when a polyester resin is used as a binder resin, it is desired to add a positive charge control agent in a large amount to positively charge the polyester resin. Furthermore, even when such a positive charge control agent is used in a large amount, the toner may not be sufficiently positively charged, which leads to a problem of the occurrence of background fouling.

As an example of the charge control agent, for example, JP 2584306 describes a technology by which the durability against ozone and NOx is improved by preparing a toner containing a hydrotalcite compound. Also, for example, there are proposed technologies in which an organic modified clay is used (refer to JOP2003-202708) and an organic modified hydrotalcite is used (refer to published Japanese translations of PCT international publication for patent applications Nos. (hereinafter referred to as PJT) 2006-500605 and 206-503313). However, simply containing a charge control agent as described in these technologies involves problems such as deterioration of charging property and the occurrence of background fouling.

### SUMMARY OF THE INVENTION

Because of these reasons, the present inventors recognize that a need exists for a toner which has and maintains a good charging property for an extended period of time, thereby stably forming quality images for a long time with a good combination of the low temperature fixability and the high temperature preservability and good anti-offset property without contaminating a development device and causing image deterioration problems such as the background fouling.

Accordingly, an object of the present invention is to provide a toner which has and maintains a good charging property for an extended period of time, thereby stably forming quality images for a long time with a good combination of the low temperature fixability and the high temperature preservability and good anti-offset property without contaminating a development device and causing image deterioration problems such as background fouling and an image forming apparatus and a process cartridge using the toner. Briefly this object and other objects of the present invention as hereinafter described will become more readily apparent and can be attained, either individually or in combination thereof, by a toner including particles including a toner composition which includes a binder resin and a coloring material. In the toner, the toner composition includes a laminate compound A in which a cation between layers is modified by an organic cation, and a laminate compound B in which an anion between layers is modified by an organic anion, the laminate compound A is of negative charging property upon particulation of the laminate compound A by dispersion or internal addition in the binder resin and the laminate compound B is of positive charging property upon particulation of the laminate compound B by dispersion or internal addition in the binder resin, and the toner is of a positive charging property.

It is preferred that, in the toner mentioned above, the laminate compound B is more abundant at a surface of the particle than the laminate compound A so that the surface of the particle is of positive charging property.

It is still further preferred that, the toner mentioned above has been granulated by emulsifying or dispersing an oil phase including the binder resin and/or a precursor thereof, the coloring material, the laminate compound A and the laminate compound B in an aqueous medium.

It is still further preferred that, in the toner mentioned above, the laminate compound A includes Si and Al and the laminate compound B includes Al and Mg.

It is still further preferred that the toner mentioned above satisfies the following relationship:

[Si/(Al+Mg+Si)](1)/[Si/(Al+Mg+Si)](2)<1.

In the relationship, [Si/(Al+Mg+Si)](2) is the elemental analysis ratio for the entire bulk detected by a fluorescent X ray analysis, and [Si/(Al+Mg+Si)](1) is the elemental analysis ratio for the surface bulk detected by an XPS analysis.

It is still further preferred that, in the toner mentioned above, the binder resin includes a polyester resin having a glass transition temperature of from 40 to 80° C.

It is still further preferred that, in the toner mentioned above, the binder resin includes a modified polyester resin.

It is still further preferred that, in the toner mentioned above, the modified polyester resin includes at least one of a urea group and a urethane group.

It is still further preferred that, in the toner mentioned above, the modified polyester resin is a resin prepared by conducting a reaction of a polyester resin having an isocyanate group at an end thereof and an amine.

It is still further preferred that the toner mentioned above is a non-magnetic one component toner having a positive charging property.

As another aspect of the present invention, an image forming apparatus is provided which includes; an image bearing member for bearing a latent electrostatic image thereon; a charging member for charging the image bearing member; an irradiation device for irradiating the surface of the image bearing member to form the latent electrostatic image thereon; a development device including the toner mentioned above for developing the latent electrostatic image; a transfer device for transferring the developed image to a transfer medium; and a fixing member for fixing the transferred image on the transfer medium.

It is preferred that, in the image forming apparatus, the transfer device includes an intermediate transfer device including an endless form.

It is still further preferred that the image forming apparatus mentioned above further includes a cleaning device for removing residual toner remaining on at least one of the image bearing member and the intermediate transfer device.

It is still further preferred that, in the image forming apparatus, a blade is provided to the cleaning device.

It is still further preferred that, in the image forming apparatus, the fixing device is a roller comprising a heating device.

It is still further preferred that, in the image forming apparatus, the fixing device is a belt including a heating device.

It is still further preferred that, in the image forming apparatus, the fixing device is an oil-free fixing device which dispenses with oil application for the fixing device.

As another aspect of the present invention, a process cartridge is provided which includes an image bearing member for bearing a latent electrostatic image thereon; a development device including the toner mentioned above for developing the latent electrostatic image; and at least one device selected from the group consisting of a charging member for charging the image bearing member, an irradiation device for irradiating the surface of the image bearing member to form the latent electrostatic image thereon, a transfer device for transferring the developed image to a transfer medium and a cleaning device for removing residual toner remaining on at least one of the image bearing member and the intermediate transfer device, wherein the process cartridge is detachably attached to an image bearing member.

These and other objects, features and advantages of the present invention will become apparent upon consideration of the following description of the preferred embodiments of the present invention taken in conjunction with the accompanying drawings. dr

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an example of a structure (a full color image forming apparatus) of the image forming apparatus of the present invention; and

FIG. 2 is a schematic diagram illustrating an example of the process cartridge of the present invention.

### DETAILED DESCRIPTION OF THE INVENTION

The present invention will be described below in detail with reference to several embodiments and accompanying drawings. The toner of the present invention includes particles containing a toner composition including at least a binder resin, a coloring material (coloring agent), a releasing material (releasing agent) and a charge control agent. The charge control agent has a composite structure formed by a laminate compound A having a negative charging property in which a cation between layers is modified by an organic cation and a laminate compound B having a positive charging property in which an anion between layers is modified by an organic anion. In addition, the laminate compound B is more abundant at the surface of the particle than the laminate compound A so that the surface of the particle is of a positive charging property.

As described above, the toner of the present invention includes a charge control agent having a composite structure formed by a laminate compound A and a laminate compound B. Furthermore, the laminate compound B is more abundant at the surface of a particle than the laminate compound A, meaning that the surface portion of the particle is of a positive charging property and the inside thereof is of a negative charging property. Thus, the polarization effect is improved so that the toner has a structure having an extremely high charging property.

The structure of the toner (particle) of the present invention can be obtained by, for example, emulsifying or dispersing an oil phase containing a binder resin (and/or a precursor thereof), a coloring material, a releasing material, a laminate compound A and a laminate compound B in an aqueous medium for granulation (O/W type wet type granulation method). By having a composite structure of the laminate compound A and the laminate compound B, the toner structure is controlled such that the surface portion of a particle has a positive charging property and the inside thereof has a negative charging property.

With regard to the method of controlling the toner structure, for example, in the O/W type wet type granulation method mentioned above, a laminate compound having a relatively good dispersion state in an oil phase in comparison with the other laminate compound tends to be locally present on the surface of a toner particle. This behavior is used as a method of controlling this toner structure. That is, the laminate compound B is locally present in the surface portion of a toner particle in a relatively large amount in comparison with the laminate compound A so that the surface of the particle can be of a positive charging property.

As a specific method, a liquid dispersion of a charge control agent (laminate compound) A and a liquid dispersion of a charge control agent (laminate compound) B are separately prepared at the stage of preparing an oil phase. In the liquid dispersion of the charge control agent B, the charge control agent B is sufficiently dispersed such that the dispersion diameter thereof is from 0.1 to 0.3 μm. In the liquid dispersion of the charge control agent A, the charge control agent A is lightly dispersed such that the dispersion diameter thereof is from 0.3 to 0.8 μm. By using the separately prepared liquid dispersions A and B as an oil phase, the charge control agent B can be locally present in a relatively large amount in the surface portion of a toner particle in comparison with the charge control agent A.

In another specific method, the surface state is controlled by changing the modification amount of an organic ion which modifies ions existing between each layer in a laminate compound A and a laminate compound B.

Specifically, by increasing the amount of cation existing between the layers of a charge control agent A modified by organic cation and decreasing the amount of anion existing between the layers of a charge control agent B modified by organic anion, the charge control agent B tends to be more easily wet by water than the charge control agent A. As a result, the charge control agent B can be locally present in a relatively large amount in the surface portion of a toner particle in comparison with the charge control agent A.

As still another specific method, a charge control agent B is dispersed in a latex functioning as a shell agent and a charge control agent A is put in the core portion. The charge control agent B can be locally present by this shelling.

These are just examples and not limiting. As long as the toner structure has a surface having a positive charging property and an inside having a negatively charging property, any method can be used.

The laminate compound A for use in the present invention preferably includes Si and Al as the main components thereof. The laminate compound B for use in the present invention preferably includes Al and Mg as the main components thereof.

As the charge control agent (laminate compound) A, a control agent having a negative charging property is preferably used which includes a monmolinite based laminate mineral in which a cation existing between the layers is modified by an organic cation.

As the charge control agent B, a control agent having a positive charging property is preferably used which includes a hydrotalcite based laminate mineral in which an anion existing between the layers is modified by an organic anion.

As described above, the toner of the present invention has a positive charging property at the surface portion of a particle and a negative charging property at the inside portion thereof. To obtain such a structure, it is preferred that a toner having a laminate compound A mainly made of Si and Al and a laminate compound B made of Al and Mg satisfies the following relationship (1):

[Si/(Al+Mg+Si)](1)/[Si/(Al+Mg+Si)](2)<1 Relationship (1),

wherein [Si/(Al+Mg+Si)](1) represents the ratio of Si to the sum of quantity of Al, Mg and Si for the surface bulk detected by XPS analysis and [Si/(Al+Mg+Si)](2) represents the ratio of Si to the sum of quantity of Al, Mg and Si for the entire bulk detected by the fluorescent X ray analysis.

As long as the relationship (1) is satisfied, the charge control agent B exists in the surface portion of a toner particle in a large amount, and the surface portion is of a positive charging property. Thus, the charge control agent A exists in the inside of a toner particle in a large amount and the inside portion is of a negative charging property. Preferably, the following relationship is satisfied: [Si/(Al+Mg+Si)](1)/[Si/(Al+Mg+Si)](2)<0.5. By this segregation, the polarization effect is strong and a toner particle has a higher charging property than a toner particle simply having a charge control agent B so that the toner particle has a positive charging property. Therefore, the toner satisfying the relationship (1) maintains a sufficient chargeability and hardly has problems such as image deterioration caused by background fouling for an extended period of use.

As described above, the toner of the present invention is preferably (spherical) particles formed by emulsifying or dispersing an oil phase including at least a binder resin and/or a precursor thereof, a coloring material, a laminate compound A and a laminate compound B in an aqueous medium for granulation (O/W type wet type granulation method). A toner that has such a spherical form can be used for a full color and high speed high precision image formation. The circularity is especially preferred to be from 0.96 to less than 0.99.

The circularity, i.e., average circularity, can be measured by the following method.

### Average Circularity

It is suitable to use an optical detection method for measuring particle forms in which particle images are optically detected by a charge coupled device (CCD) camera while a suspension containing particles passes through an imaging detective portion having a plate form. The average circularity of the particle is determined by dividing the circumferential length of the circle having the area equal to a projected toner area with the circumferential length of the projected toner area. This value is a value measured by a flow type particle image analyzer (FPIA-2100, manufactured by Sysmex Corporation) as the average circularity. The specific procedure for obtaining the average circularity is as follows:
1) A surface active agent serving as a dispersion agent, preferably 0.1 to 5 ml of an alkylbenzenesulfonic acid salt, is added to 100 to 150 ml of water from which solid impurities have been preliminarily removed;
2) About 0.1 to 0.5 g of a sample to be measured is added to the mixture prepared in (1);
3) The liquid suspension prepared in (2) in which the sample is dispersed is subjected to an ultrasonic dispersion treatment for about 1 to 3 minutes such that the concentration of the particles is 3,000 to 10,000 particles per micro litter; and
4) The form and the particle size distribution of the sample are measured by the instrument mentioned above.

In addition, when the toner of the present invention has an excessively small volume average particle diameter, each process in image formation may be adversely affected. When the toner of the present invention has an excessively large volume average particle diameter, the image definition may decrease. The volume average particle diameter of toner particles is described below.

### Measuring Method of Particle Diameter of Toner Particle

Coulter Counter TA-II or Coulter Multisizer II (both are manufactured by Beckman Coulter Co., Ltd.) can be used as the measuring device for toner particle diameter and particle size distribution by Coulter Counter Method. Toner particle diameter and toner particle size distribution are measured by Coulter Counter Method as follows: Add 0.1 to 5 ml of a surface active agent, preferably a salt of an alkyl benzene sulfonate, as a dispersant to 100 to 150 ml of an electrolytic aqueous solution, which is about 1% NaCl aqueous solution prepared by using primary NaCl and pure water, for example, ISOTON-II (manufactured by Beckman Coulter, Inc.) can be used; Add 2 to 20 mg of a toner as a measuring sample to the electrolytic aqueous solution; Conduct dispersion treatment for the electrolytic aqueous solution in which the measuring sample is dispersed for about 1 to 3 minutes by a ultrasonic dispersion device; Measure the volume and the number of the toner particles or the toner by the device mentioned above with an aperture of 100 μm; and calculate the volume distribution and the number distribution. The weight average particle diameter (Dv) and the number average particle diameter (Dp) of the toner can be obtained based on the obtained distributions. The weight average particle diameter (Dv) and the number average particle diameter (Dp) of the toner can be obtained based on the obtained distributions.

The whole range is a particle diameter of from 2.00 to not greater than 40.30 μm and the number of the channels is 13. Each channel is, for example, from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm.

Next, the toner composition is described.

### Charge Control Agent A

As described above, the charge control agent A is a control agent having a negative charging property. A charge control agent formed by a laminate mineral in which the cation between the layers is modified by an organic cation is preferably used. For example, an organic modified clay such as a charge control agent formed of momolinite based laminate mineral in which the cation between layers is modified by an organic cation is suitably used. Specific examples thereof include, but are not limited to, laminate compounds as described in PJT 2003-515795.

### Charge Control Agent B

As described above, the charge control agent B is a control agent having a positive charging property. A charge control agent formed by a laminate mineral in which the anion between the layers is modified by an organic anion is preferably used. A charge control agent formed of hydrotalcite based laminate mineral in which the anion between layers is modified by an organic anion is suitably used. Specific examples thereof include, but are not limited to, laminate compounds as described in PJTs 2006-5503313 and 2006-500605.

As described in the method described above, the surface portion of a particle is of a positive charging property by making the charge control B more present therein than the charge control A.

### Binder Resin

As the binder resin used as a component of a toner composition, any resin can be used as long as the resin can be granulated by O/W type wet type granulation method in which the resin is dissolved or dispersed in a solvent together with other composition elements such as a coloring material, a releasing material and charge control agents A and B and can control the toner structure in the predetermined manner (i.e., making the charge control B more present in the surface of a particle than the charge control A). In light of having a good combination of the low temperature fixing property and the high temperature preservability, it is preferred to contain a polyol resin as the binder resin.

According to the study made by the present inventors, it is preferred to contain a polyester resin having a glass transition temperature (Tg) of from 40 to 80° C. as the binder resin. In the case of a polyester resin that has an excessively low glass transition temperature, the high temperature preservability tends to be insufficient. When the glass transition temperature thereof is too high, the low temperature fixing tends to be not sufficient. The toner of the present invention has a relatively good high temperature preservability in comparison with a known polyester based toner even when the glass transition temperature of the toner of the present invention is low. This is because a modified polyester resin such as a urea modified polyester resin, which is described later, is coexistent in the toner of the present invention.

### Glass Transition Temperature

The glass transition temperature (Tg) of polyester resins and vinyl based copolymer resins can be measured by using, for example, a differential scanning calorimeter (e.g., DSC-6220R, manufactured by Seiko Instruments Inc.) as follows: Heat a sample from room temperature to 150° C. at a temperature rise speed of 10° C./min; Leave the sample at 150° C. for 10 minutes; Cool down the sample to room temperature; Leave the sample for 10 minutes; Heat the sample again to 150° C. at a temperature rise speed of 10° C./min; and obtain the glass transition temperature as the intersection of the base line below the glass transition temperature and the tangent of the curve portion indicating the glass transition.

As the binder resin described above, it is preferred to contain a modified polyester resin. Especially, such a modified polyester resin preferably contains a urethane group and/or a urea group. Containing a modified polyester resin is convenient to improve the low temperature fixing and the high temperature preservability and suitable for an oil free fixing system.

In addition, the modified polyester resin is preferably prepared by conducting reaction between a polyester resin having an isocyanate group at its end and an amine.

Modified polyesters such as a urea-modified polyester obtained by conducting reaction between a polyester prepolymer resin having an isocyanate group at its end and an amine are easy to control the molecular weight of the polymer composition thereof and especially suitable for securing oil free low temperature fixing property. Furthermore, a urea-modified polyester resin in which the end of a polyester prepolymer is urea-modified can restrain adhesiveness to a heating medium for fixing while keeping high fluidity and transparency in the fixing temperature range of a non-modified polyester resin.

The modified polyester resin mentioned above is, for example, a polyester (prepolymer) having an isocyanate group reactive with an active hydrogen. Such a polyester prepolymer (A) can be prepared by, for example, reacting a polyester having an active hydrogen group, which is a polycondensation product of a polyol (PO) and a polycarboxylic acid (PC), and a polyisocyanate (PIC). Specific examples of the active hydrogen group contained in the polyesters including the mentioned above include, but are not limited to, hydroxyl groups (alcohol hydroxyl groups and phenol hydroxyl groups), amino groups, carboxylic groups, and mercarpto groups. Among these, alcohol hydroxyl groups are particularly preferred.

When a polyester prepolymer (A) is used as a binder resin, the O/W type wet type granulation method is used to form a toner in which a lysate or a dispersion material is formed by dissolving or dispersing a prepolymer (A), a compound having an active hydrogen compound, a coloring material (coloring agent), a releasing material (a releasing agent), a charge control agent A and a charge control agent B in a solvent followed by reacting the lysate or the dispersion material with a cross-linking agent and/or an elongation agent in an aqueous medium containing a dispersion agent.

As the polyols (PO) mentioned above, suitable polyols (PO) include diols (DIO) and polyols (TO) having three or more hydroxyl groups. It is preferred to use a diol (DIO) alone or mixtures in which a small amount of a polyol (TO) is mixed with a diol (DIO).

Among these compounds, alkylene glycols having 2 to 12 carbon atoms and adducts of a bisphenol with an alkylene oxide are preferable. More preferably, an adduct of a bisphenol with an alkylene oxide, or a mixture of an adduct of a bisphenol with an alkylene oxide and an alkylene glycol having 2 to 12 carbon atoms are used.

Specific examples of the polyols (TO) include, but are not limited to, aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the tri-or higher polyphenols mentioned above with an alkylene oxide; etc.

Suitable polycarboxylic acids (PC) include dicarboxylic acids (DIC) and polycarboxylic acids (TC) having three or more carboxyl groups. It is preferred to use a dicarboxylic acid (DIC) alone or a mixture in which a small amount of a polycarboxylic acid (TC) is mixed with a dicarboxylic acid (DIC).

As suitable polycarboxylic acids (PC), it is possible to use a compound made by reacting an anhydride or a lower alkyl ester (e.g., methyl esters, ethyl esters or isopropyl esters) of the polycarboxylic acids mentioned above with a polyol.

A suitable mixing ratio (i.e., an equivalence ratio [OH]/[COOH]) of a polyol (PO) to a polycarboxylic acid (PC) is from 2/1 to 1/1, preferably from 1.5/1 to 1/1 and more preferably from 1.3/1 to 1.02/1.

Specific examples of the polyisocyanates (3) include, but are not limited to, aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic diisosycantes (e.g., tolylene diisocyanate and diphenylmethane diisocyanate); aromatic aliphatic diisocyanates (e.g., α, α, α′, α′-tetramethyl xylylene diisocyanate); isocyanurates; blocked polyisocyanates in which the polyisocyanates mentioned above are blocked with phenol derivatives thereof, oximes or caprolactams; etc. These compounds can be used alone or in combination.

Suitable mixing ratio (i.e., [NCO]/[OH]) of a polyisocyanate (PIC) to a polyester having a hydroxyl group is from 5/1 to 1/1, preferably from 4/1 to 1.2/1 and more preferably from 2.5/1 to 1.5/1. When the [NCO]/[OH] ratio is too large, the low temperature fixability of the toner deteriorates. When the molar ratio of [NCO] is too small, the urea content of a modified polyester tends to be small and the hot offset resistance easily deteriorates.

The content of the constitutional component of a polyisocyanate (PIC) in the polyester prepolymer (A) having a polyisocyanate group at its end portion is from 0.5 to 40% by weight, preferably from 1 to 30% by weight and more preferably from 2 to 20% by weight. When the content is too low, the hot offset resistance of the toner deteriorates and in addition the high temperature preservability and low temperature fixability of the toner have disadvantages in light of their combination. In contrast, when the content is too high, the low temperature fixability of the toner deteriorates.

The number of isocyanate groups included in the prepolymer (A) per molecule is normally not less than 1, preferably from 1.5 to 3, and more preferably from 1.8 to 2.5. When the number of isocyanate groups is too small, the molecular weight of urea-modified polyester tends to be small and the hot offset resistance easily deteriorates.

Specific examples of the amines (B) include, but are not limited to, diamines (B1), polyamines (B2) having three or more amino groups, amino alcohols (B3), amino mercaptans (B4), amino acids (B5), and blocked amines (B6) in which the amines (B1-B5) mentioned above are blocked. Among these compounds, diamines (B1) and mixtures in which a diamine (B1) is mixed with a small amount of a polyamine (B2) are preferred.

The molecular weight of the polyester can be controlled using a molecular-weight control agent, if desired. Specific preferred examples of the molecular-weight control agent include, but are not limited to, monoamines (e.g., diethyl amine, dibutyl amine, butyl amine and lauryl amine), and blocked amines (i.e., ketimine compounds) prepared by blocking the monoamines mentioned above

The mixing ratio of the amines (B) to the prepolymer (A), i.e., the equivalent ratio ([NCO]/[NHx]) of the isocyanate group [NCO] contained in the prepolymer (A) to the amino group [NHx] contained in the amines (B), is normally from 1/2 to 2/1, preferably from 1.5/1 to 1/1.5 and more preferably from 1.2/1 to 1/1.2. When the mixing ratio is too large or too small, the molecular weight of the resultant polyester decreases, resulting in deterioration of the hot offset resistance of the resultant toner.

In the present invention, preferably used polyester resins as a binder resin are urea-modified polyesters (UMPE). In these modified polyesters, a urethane linkage can be included as well as a urea linkage. The molar ratio (urea/urethane) of the urea linkage to the urethane linkage may vary from 100/0 to 10/90, preferably from 80/20 to 20/80 and more preferably from 60/40 to 30/70. When the content of the urea linkage is too low, for example, less than 10%, the hot offset resistance of the resultant toner deteriorates.

Modified polyesters such as urea-modified polyesters (UMPE) can be prepared in different ways, including, for example, a one-shot method. The weight average molecular weight of the urea-modified polyesters (UMPE) is not less than 10,000, preferably from 20,000 to 10,000,000 and more preferably from 30,000 to 1,000,000. When the weight molecular weight is too small, hot offset resistance tends to deteriorate. The number average molecular weight of the modified polyester such as the urea-modified polyester is not particularly limited when an unmodified polyester resin, which is described later, is used in combination. Namely, controlling of the weight average molecular weight of the modified polyester resins has priority over controlling of the number average molecular weight thereof. However, when a modified polyester such as a urea-modified polyester (UMPE) is used alone, the number average molecular weight thereof is from 2,000 to 15,000, preferably from 2,000 to 10,000 and more preferably from 2,000 to 8,000. When the number average molecular weight is too large, the low temperature fixability of the resultant toner tends to deteriorate, and in addition the gloss of full color images decreases when the toner is used in a full color image forming apparatus.

In the present invention, by using a combination of a urea-modified polyester (UMPE) with an unmodified polyester (PE) as the component of a binder resin, the low temperature fixability of a toner improves and in addition the toner can produce color images having a good gloss property when the toner is used in a full-color image forming apparatus. That is, using this combination is preferable to a single use of a urea-modified polyester (UMPE).

As the unmodified polyester (PE), a polycondensation product of the polyol (PO) and the polycalboxylic acid (PC) as in the polyester component of the urea-modified polyester (UMPE) and preferred examples are the same as those for the urea-modified polyester (UMPE). The weight average molecular weight (Mw) of the unmodified polyester is from 10,000 to 300,000 and preferably from 14,000 to 200,000. The number average molecular weight (Mn) thereof is from 1,000 to 10,000 and preferably from 1,500 to 6,000. The urea-modified polyester resin (UMPE) can be also used in combination with a modified polyester in addition to a non-modified polyester. For example, a modified polyester resin which is modified by a chemical linkage other than urea linkage, for example, urethane linkage, can be used in combination. When a mixture of the urea-modified polyester (UMPE) and the unmodified polyester (PE) is used, it is preferred that the urea-modified polyester (UMPE) at least partially mixes with the unmodified polyester (PE) in terms of the low temperature fixability and hot offset resistance of the resultant toner. Namely, it is preferred that the urea-modified polyester (UMPE) has a structure similar to that of the unmodified polyester (PE).

The weight ratio of the urea-modified polyester (UMPE) to the unmodified polyester (PE) is from 5/95 to 80/20, preferably from 5/95 to 30/70, more preferably from 5/95 to 25/75 and particularly preferably from 7/93 to 20/80 when the unmodified polyester (PE) is contained. When the ratio of the urea-modified polyester (UMPE) is too small, for example, less than 5%, the hot offset resistance tends to deteriorate and it is disadvantageous in terms of a combination of the high temperature preservability and the low temperature fixing property.

The hydroxyl value (mgKOH/g) of the unmodified polyester (PE) is preferably not less than 5 and the acid value (mgKOH/g) of the unmodified polyester (PE) is from 1 to 30 and preferably from 5 to 20. The unmodified polyester (PE) tends to be of a negative charging property by having such an acid value. In addition, the affinity of toner to paper is improved during fixing of a toner image on the paper so that the low temperature fixability is improved. However, an acid value that is excessively large has an adverse impact on the charge stability and especially to environmental change. A variance in the acid value in the polymerization reaction leads to a variance in the granulation process and thus controlling emulsification is difficult.

The acid value is measured according to the measuring method described in JIS K0070-1992. In addition, the hydroxyl value is measured according to the measuring method described in JIS K0070-1966.

### Releasing Agent

As a wax (releasing agent) for use in the toner of the present invention, a wax having a suitable melting point effectively functions in the dispersion in a binder resin at the interface between a fixing roller and a toner. Thereby, without applying a releasing agent such as oil to a fixing roller, the toner has a good hot offset resistance. The melting point of the wax for use in the present invention is the maximum endothermic peak according to the differential scanning calorimeter (DSC).

The following material can be used as the wax component functioning as the releasing agent for use in the present invention.

Specific examples of such waxes include, but are not limited to, natural waxes such as plant waxes such as carnauba wax, cotton wax, haze wax, and rice wax, animal waxes such as yellow bees wax and lanoline, mineral waxes such as ozokerite and petroleum waxes such as paraffin, microcrystalline wax and petrolatum. Other than these natural waxes, synthetic hydrocarbon waxes such as Fisher-Tropsch wax and polyethylene wax, and synthetic waxes such as esters, ketons, and ethers can be used. Further, fatty acid amides such as 1,2-hydroxystearic acid amide, stearic acid amides, anhydrous phthalic acid imides and chlorinated hydrocarbons, homo polymers or copolymers (e.g., copolymers of n-staryl acrylate-ethylmethacrylate) of a polyacrylate, which is a crystalline polymer resin having a relatively low molecular weight, such as poly-n-stearyl methacrylate and poly-n-lauric methacrylate, and crystalline polymers having a long chain alkyl group on its branched chain can be also used.

### Coloring Agent

There is no specific limit to the coloring agents for use in the toner Specific examples thereof include, but are not limited to, carbon black, Nigrosine dyes, black iron oxide, Naphthol Yellow S, HANSA Yellow (10G, 5G and G), Cadmium Yellow, yellow iron oxide, loess, chrome yellow, Titan Yellow, polyazo yellow, Oil Yellow, HANSA Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, LITHOL Fast Scarlet G, Brilliant Fast Scarlet, Brilliant Carmine BS, Permanent Red (F2R, F4R, FRL, FRLL and F4RH), Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, PYRAZOLONE Red, polyazo red, Chrome Vermilion, Benzidine Orange, perynone orange, Oil Orange, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and a mixture thereof. The content of such a coloring agent is from 1 to 15% by weight and preferably from 3 to 10% by weight.

Master batch pigments, which are prepared by combining a coloring agent with a binder resin, can be used as the coloring agent of the toner composition of the present invention.

Specific examples of the binder resins for use in the master batch pigments or for use in combination with master batch pigments include, but are not limited to, the modified polyester resins and the unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins can be used alone or in combination.

The master batch mentioned above is typically prepared by mixing and kneading a resin and a coloring agent upon application of high shear stress thereto. In this case, an organic solvent can be used to boost the interaction of the coloring agent with the resin. In addition, flushing methods in which an aqueous paste including a coloring agent is mixed with a resin solution of an organic solvent to transfer the coloring agent to the resin solution and then the aqueous liquid and organic solvent are removed can be preferably used because the resultant wet cake of the coloring agent can be used as it is. In this case, a high shear dispersion device such as a three-roll mill is preferably used for mixing and kneading the mixture. Manufacturing of Toner by O/W Type Wet Type Granulation Method

The toner of the present invention can be manufactured by an O/W type wet type granulation method. An Example thereof is as follows:

### Synthesis of Polyester

The polyol (PO) mentioned above (e.g., an adduct of bisphenol A with 2 mol of ethylene oxide, an adduct of bisphenol A with 2 mol of propylene oxide) and the polycarboxylic acid (PC) mentioned above (e.g., terephthalic acid, adipic acid, an anhydride of trimellitic acid) are placed in a reaction container equipped with a condenser, stirrer and a nitrogen introducing tube as raw material to conduct a polymerization reaction under the presence of a catalyst (e.g., dibutyltin oxide) for synthesis of a polyester (1a) (Number average molecular weight: about 2,200; Weight average molecular weight: about 5,600; Glass transition temperature (Tg): about 43° C.; Acid value: about 13).

### Synthesis of Prepolymer

The polyol (PO) mentioned above (e.g., an adduct of bisphenol A with 2 mol of ethylene oxide, an adduct of bisphenol A with 2 mol of propylene oxide) and the polycarboxylic acid (PC) mentioned above (e.g., terephthalic acid, an anhydride of trimellitic acid) are placed in a reaction container equipped with a condenser, stirrer and a nitrogen introducing tube as raw material to conduct a polymerization reaction under the presence of a catalyst (e.g., dibutyltin oxide) for synthesis of an intermediate polyester 1b (Number average molecular weight: about 2,100; Weight average molecular weight: about 9,500; Glass transition temperature (Tg): about 55° C.; Acid value: about 0.5; Hydroxyl value: about 49).

Next, the intermediate polyester 1b, the polyisocyanate (PIC) mentioned above (e.g., isophorone diisocyanate) and a solvent (e.g., ethyl acetate) are placed in a reaction container to synthesize a prepolymer 1c (Weight % of isolated isocyanate: about 1.53%).

### Preparation of Master Batch

A pigment (e.g., carbon black), a binder resin [e.g., polyester resin (Acid value: about 10; Weight average molecular weight (Mw): about 20,000; Glass transition temperature: about 64° C.) and water are mixed by a HENSCHEL MIXER to obtain a mixture in which water sops in an pigment agglomeration body. The mixture is mixed and kneaded for a predetermined time by two rolls of which the surface is set at a predetermined temperature (e.g., about 130° C.). The resultant is pulverized to a size of about 1 mm φ by a pulverizer. Thus, Master batch 1 is obtained.

### Manufacturing of Liquid Dispersion of Laminate Compound A Having Negative Charging Property

A laminate compound A having a negative charging property which is modified by an organic cation {e.g., a momolinite laminate mineral modified by tertiary ammonium ion (cation)}, Polyester 1, and a solvent (e.g., ethyl acetate) are mixed by a mixer while the number of rotation thereof is adjusted. Thus, a liquid dispersion of laminate compound liquid dispersion A having a dispersion diameter of from about 0.3 to about 0.8 μm is obtained.

### Manufacturing of Liquid Dispersion of Laminate Compound B Having Positive Charging Property

A laminate compound B having a positive charging property which is modified by an organic anion {e.g., a hydrotalcite modified by a long chain aliphatic acid ion (anion)}, Polyester 1, and a solvent (e.g., ethyl acetate) are mixed by a mixer while the number of rotation thereof is adjusted. Thus, a liquid dispersion of laminate compound liquid dispersion B having a dispersion diameter of from about 0.1 to about 0.3 μm is obtained.

### Preparation of Pigment and Wax Liquid Dispersion (Oil Phase)

Polyester 1 mentioned above, a wax (e.g., paraffin wax), and a solvent (e.g., ethyl acetate) are placed in a reaction container equipped with a stirrer and a thermometer in a predetermined amount for each. Subsequent to a temperature rising treatment by heating (e.g., stirring at about 80° C.), the entire system is cooled down to room temperature (about 30° C.). Then, Master batch 1 mentioned above and a solvent (e.g., ethyl acetate) are placed in the reaction container followed by about one hour mixing to obtain a raw material solution 1.

A predetermined amount of Raw material solution 1 is transferred to a vessel to disperse carbon black and wax using a bead mill (ULTRAVISCOMILL from AIMEX) under the following conditions:

Liquid feeding speed: 1 kg/hr

Disc rotation perimeter speed: 6 m/sec

Diameter of zirconia beads: 0.5 mm

Filling factor of zirconia beads: 80% by volume

Repeat number of dispersion treatment: 3 times

Next, the solution of Polyester 1a (e.g., 65% ethyl acetate solution) is added to the liquid dispersion. After 1 pass of the bead mill under the same condition mentioned above, a pigment and wax liquid dispersion 1 is obtained. The solid portion density of the pigment and wax liquid dispersion 1 is adjusted by a solvent (e.g., ethyl acetate) to be, for example, 50%.

### Preparation of Aqueous Phase

Aqueous phase 1 is prepared by mixing and stirring a predetermined amount of each of a deionized water, organic resin particulates (e.g., an aqueous liquid dispersion of a copolymer of a sodium salt of sulfate of an adduct of methacrylic acid with ethyleneoxide), and an aqueous solvent (e.g., ethyl acetate) of sodium dodecyldiphenylether disulfonate.

### Emulsification

Pigment and wax liquid dispersion 1, the laminate compound liquid dispersion A, the laminate compound liquid dispersion B and an amine (e.g., isophorone diamine) are mixed by a mixer (e.g., TK HOMOMIXER, manufactured by Tokushu Kika Kogyo Co., Ltd.) for one minute. Prepolymer 1c is added thereto and the resultant is mixed with the same mixer (about 5,000 rpm). Then, Aqueous phase 1 is added thereto in a ratio of about 1,200 parts of the aqueous phase 1 to about 1,100 parts of the total amount of the pigment and wax liquid dispersion 1 and Prepolymer 1c followed by mixing by the same mixer (about 8,000 to about 13,000 rpm) to obtain Emulsion slurry 1.

### Removing Solvent

In a container equipped with a stirrer and a thermometer, Emulsion slurry 1 is set and the solvent is removed at around 30° C. Thus, Slurry dispersion 1 is obtained.

### Washing and Drying

Emulsion slurry 1 is filtered under a reduced pressure. Then, the following operations are conducted:
(a) Deionized water is added to the thus prepared filtered cake and the mixture is mixed by a mixer (e.g., TK HOMOMIXER at a revolution number of 12,000 rpm for about 10 minutes) and then filtered to obtain a filtered cake;
(b) Deionized water is added to the filtered cake prepared in (a) and the resultant is mixed by a mixer (e.g., a TK HOMOMIXER at a rotation number of 12,000 rpm for 30 minutes) while applying ultrasonic vibration thereto, and then filtered under a reduced pressure. This operation is repeated until the electric conductivity of the slurry liquid is not greater than 10 μC/cm;
(c) Hydrochloric acid (density of about 10%) is added to the slurry liquid prepared in (b) to make a pH of the slurry liquid to be 4 followed by stirring by a stirring motor and filtering. Thus, a filtered cake is obtained; and
(d) Deionized water is added to the filtered cake prepared in (c) and the resultant is mixed by a mixer (e.g., a TK HOMOMIXER at a rotation number of 12,000 rpm for about 10 minutes) followed by filtration. This operation is repeated until the electric conductivity of the slurry liquid is not greater than 10 μC/cm.

Thus, Filtered cake 1 is obtained.

Filtered cake 1 is dried by a drier (e.g., a circulating drier, at 45° C. for about 48 hours). The dried cake is sieved using a screen (e.g., a sieve having openings of 75 μm) to obtain Mother toner 1. Mother toner 1 is optionally mixed with hydrophobic silica and hydrophobic titan oxide by a mixer (e.g., a HENSCHEL MIXER). Developing agent 1 is thus prepared which has a composite structure formed of a laminate compound A and a laminate compound B and has a surface portion of a positive charging property.

Suitable aqueous media for use in the present invention include water, and mixtures of water with a solvent which can be mixed with water. Specific examples of such a solvent include, but are not limited to, alcohols (e.g., methanol, isopropanol and ethylene glycol), dimethylformamide, tetrahydrofuran, cellosolves (e.g., methyl cellosolve), lower ketones (e.g., acetone and methyl ethyl ketone), etc.

In the present invention, a urea-modified polyester (UMPE) can be obtained by conducting a reaction between a reactive modified polyester such as a polyester prepolymer A having an isocyanate group and an amine (B) in an aqueous medium. As a method of stably forming a dispersion body formed of a reactive modified polyester and a prepolymer (A) such as a urea-modified polyester in an aqueous medium, there is a method in which a composition of a toner material formed of a reactive modified polyester and a prepolymer (A) such as a urea-modified polyester is added to an aqueous medium followed by dispersion using a shearing force.

The amount of an aqueous medium is normally from 50 to 2,000 parts by weight and preferably from 100 to 1,000 parts by weight based on 100 parts by weight of a toner composition containing a polyester such as a urea modified polyester and a prepolymer (A). When the amount of an aqueous medium is too small, the dispersion stability of a toner composition is degraded so that toner particles having a desired particle diameter are not obtained. An amount of an aqueous medium that is excessively large is not preferred in light of economy. A dispersion agent can be used, if desired. It is preferred to use a dispersion agent in terms that the particle distribution is sharp and the dispersion is stable.

Various kinds of dispersion agents are used for emulsification and dispersion of an oil phase in an aqueous phase.

Specific examples of such a dispersion agent include, but are not limited to a surface active agent, an inorganic particulate dispersion agent, a polymer particulate dispersion agent, etc.

Specific examples of the surface active agents include, but are not limited to, anionic dispersion agents, for example, alkylbenzene sulfonic acid salts, α-olefin sulfonic acid salts, and phosphoric acid salts; cationic dispersion agents, for example, amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic dispersion agents, for example, fatty acid amide derivatives, polyhydric alcohol derivatives; and ampholytic dispersion agents, for example, alanine, dodecyldi(aminoethyl)glycin, di(octylaminoethyle)glycin, and N-alkyl-N,N-dimethylammonium betaine.

A good dispersion can be prepared with an extremely small amount of a surface active agent having a fluoroalkyl group. Preferred specific examples of the anionic surface active agents having a fluoroalkyl group include, but are not limited to, fluoroalkyl carboxylic acids having from 2 to 10 carbon atoms and their metal salts, disodium perfluorooctane sulfonyl glutamate, sodium 3-{omega-fluoroalkyl(C6-C11)oxy}-1-alkyl(C3-C4)sulfonate, sodium 3-{omega-fluoroalkanoyl(C6-C8)-N-ethylamino}-1-propanesulfonate, fluoroalkyl(C11-C20)carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such anionic surface active agents having a fluoroalkyl group include, but are not limited to, SURFLON® S-111, S-112 and S-113, which are manufactured by Asahi Glass Co., Ltd.; FRORARD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-110, F-120, F-113, F-191, F-812 and F-833 which are manufactured by Dainippon Ink and Chemicals, Inc.; ECTOP® EF-102, 103, 104, 105, 112, 123A, 306A, 501, 201 and 204, which are manufactured by Tohchem Products Co., Ltd.; FUTARGENT® F-100 and F150 manufactured by Neos; etc.

Specific examples of the cationic surface active agents having a fluoroalkyl group include, but are not limited to, primary, secondary and tertiary aliphatic amino acids, aliphatic quaternary ammonium salts (for example, perfluoroalkyl(C6-C10)sulfoneamidepropyltrimethyl ammonium salts), benzalkonium salts, benzetonium chloride, pyridinium salts, and imidazolinium salts.

Specific examples of the marketed products of such catiotic surface active agents having a fluoroalkyl group include, but are not limited to, SURFLON® S-121 (from Asahi Glass Co., Ltd.); FRORARD® FC-135 (from Sumitomo 3M Ltd.); UNIDYNE® DS-202 (from Daikin Industries, Ltd.); MEGAFACE® F-150 and F-824 (from Dainippon Ink and Chemicals, Inc.); ECTOP® EF-132 (from Tohchem Products Co., Ltd.); FUTARGENT® F-300 (from Neos); etc.

In addition, a water hardly soluble inorganic dispersing agents can be used. Specific examples thereof include, but are not limited to, tricalcium phosphate, calcium carbonate, titanium oxide, colloidal silica and hydroxyapatite.

Particulate polymers have been confirmed to have the same effect as an inorganic dispersing agent.

Specific examples of the particulate polymers include, but are not limited to, particulate polymethyl methacylate (MMA) having a particle diameter of 1 and 3 μm, particulate polystyrene having a particle diameter of 0.5 and 2 μm, particulate styrene-acrylonitrile copolymers having a particle diameter of 1 μm, etc. Specific examples of the marketed particulate polymers include, but are not limited to, PB-200H (available from Kao Corp.), SGP (available from Soken Chemical & Engineering Co., Ltd.), TECHNOPOLYMER® SB (available from Sekisui Plastics Co., Ltd.), SPG-3G (available from Soken Chemical & Engineering Co., Ltd.), MICROPEARL® (available from Sekisui Fine Chemical Co., Ltd.), etc.

Furthermore, it is possible to stably disperse toner components in an aqueous medium using a polymeric protection colloid in combinational use with the inorganic dispersing agents and particulate polymers mentioned above. Specific examples of such protection colloids include, but are not limited to, polymers and copolymers prepared using monomers, for example, acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g., acrylamide, methacrylamide and diacetoneacrylamide) and their methylol compounds, acid chlorides (e.g., acrylic acid chloride and methacrylic acid chloride), and homopolymers or copolymers having a nitrogen atom or an alicyclic ring having a nitrogen atom (e.g., vinyl pyridine, vinyl pyrrolidone, vinyl imidazole and ethylene imine).

In addition, polymers, for example, polyoxyethylene based compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters), and cellulose compounds, for example, methyl cellulose, hydroxyethyl cellulose and hydroxypropyl cellulose, can also be used as the polymeric protective colloid.

To decrease the viscosity of a medium dispersion containing a toner component, it is possible to use an organic solvent in which a polyester, for example, a urea-modified polyester and a prepolymer (A), can be dissolved. It is preferred to use a solvent because the particle size distribution can be sharp. The organic solvent is preferred to be volatile and have a boiling point lower than 100° since it is easy to get removed.

Specific examples thereof include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone and methylisobuthyl ketone. These can be used alone or in combination. Especially, aromatic series based solvent, for example, toluene and xylene, and halogenated hydrocarbons, for example, methylene chloride, 1,2-dichloroethane, chloroform and carbon tetrachloride, are preferred.

The content of the organic solvent is from 0 to 300 parts by weight, preferably from 0 to 100 parts by weight and more preferably from 25 to 70 parts by weight based on 100 parts by weight of a prepolymer (A). When such a solvent is used, the solvent is removed from the resultant product under normal pressure or a reduced pressure after the elongation and/or cross-linking reaction of a modified polyester (prepolymer) by an amine.

The cross-linking time and/or the elongation time is determined depending on the reactivity determined by the combination of the structure of the isocyanate group in a prepolymer (A) and an amine (B). The cross-linking time and/or the elongation time is in general from 10 minutes to 40 hours, and preferably from 2 to 24 hours. The reaction temperature is generally from 0 to 150° C., and preferably from 40 to 98° C. In addition, a known catalyst can be optionally used. Specific examples of such elongation agents and/or cross-linking agents include, but are not limited to, dibutyltin laurate and dioctyltin laurate. Specific examples of such an elongation agent and/or a cross-linking agent include, but are not limited to, the amines (B) mentioned above.

The ratio (Dv/Dn) of the volume average particle diameter (Dv) of a toner to the number average particle diameter (Dn) thereof mentioned above can be controlled by adjusting, for example, the aqueous phase viscosity, the oil phase viscosity, characteristics of resin particulates and the addition amount. In addition, Dv and Dn can be controlled by adjusting characteristics of resin particulates, the addition amount, etc.

In the toner of the present invention, the ratio (Dv/Dn) of the volume average particle diameter (Dv) of the toner and the number average particle diameter (Dn) of the toner is preferably from 1.00 to 1.30. In this range, high definition quality images can be obtained. Furthermore, in the case of a two component developing agent, the variance of the particle diameter of the toner in the two component developing agent can be reduced even when the toner is repeatedly replenished over an extended period of time, and the excellent development property can be maintained against stirring in the development device over an extended period of time.

When the ratio (Dv/Dn) is too large, the variance of the particle diameter among each toner particle tends to be large and the behavior thereof varies during development. This easily leads to the reproducibility of microdots, which prevents production of quality images.

In the toner of the present invention, the volume average particle diameter (Dv) is preferably from 3.0 to 7.0 μm.

An external additive can be added to the toner of the present invention to help improving the fluidity, developability, chargeability of coloring agents. Inorganic particulates are suitably used as such an external additive. It is preferred for the inorganic particulate to have a primary particle diameter of from 5 nm to 2 μm, and more preferably from 5 nm to 500 nm. In addition, it is preferred that the specific surface area of such inorganic particulates measured by a BET method is from 20 to 500 m²/g. The content of such an inorganic particulate is preferably from 0.01 to 5% by weight and particularly preferably from 0.01 to 2.0% by weight based on the weight of a toner.

Specific examples of such inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

As a fluidity agent, it is preferred to use hydrophobic silica particulates and hydrophobic titanium oxide particulates in combination. Especially when stirring and mixing are performed using such particulates having an average particle diameter of not greater than 50 nm, the electrostatic force and van der Waals force with a toner are extremely ameliorated. Therefore, during stirring and mixing in the development device performed for obtaining a desired level of charging, a fluidity agent is not detached from a toner particle so that quality images can be obtained and the amount of toner remaining after transfer is reduced.

### Image Forming Apparatus

The image forming apparatus of the present invention is described in detail with reference to the accompanying drawings.

The image forming apparatus of the present invention includes an image bearing member, a charging device, an irradiating device, a developing device in which the toner of the present invention is filled, a transfer device and a fixing device.

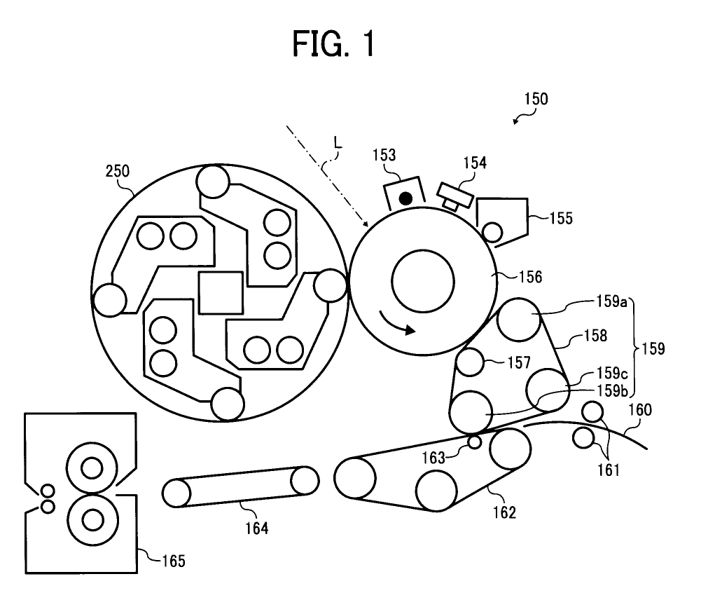

FIG. 1 is an example of the image forming apparatus and a schematic diagram illustrating a structure example of a full color image forming apparatus.

In FIG. 1, an image bearing member 156 of a full color image forming apparatus 150 is rotationally driven counterclockwise. The surface of the image bearing member 156 is uniformly charged by a charging device 153 using a corotron or scorotron. Thereafter, an optical laser device (not shown) functioning as an irradiating device scans the surface of the image bearing member 156 with a laser beam L to form a latent electrostatic image thereon. This scanning is based on image information of a full color image separated into each single color information of yellow, magenta, cyan and black. Therefore, on the image bearing member 156, a single color latent electrostatic image of yellow, magenta, cyan or black is formed.

On the left side of FIG. 1 relative to the image bearing member having a drum form, a revolver development unit 250 is provided. In the rotating case thereof having a drum form, a yellow development device, a magenta development device, a cyan development device and a black development device are provided and each development device is sequentially moved by rotation to the development position opposing the image bearing drum 156. Each of the yellow development device, the magenta development device, the cyan development device and the black development device accommodates the toner having the controlled structure of the present invention and develops the latent electrostatic image with yellow, magenta, cyan or black toner. That is, the latent electrostatic images of yellow, magenta, cyan and black are sequentially formed and developed on the image bearing member 156 by each development device in the revolver development unit 250. A yellow toner image, a magenta toner image, a cyan toner image and a black color toner image are thus formed.

On the downstream side of the image bearing member 156 relative to the development position mentioned above, an intermediate transfer unit 159 is provided. The intermediate transfer unit 159 includes an intermediate transfer belt 158, which is suspended by an intermediate transfer bias roller 157 functioning as a transfer device, a suspension roller 159a, a secondary transfer backup roller 159b and a belt driving roller 159c. The belt driving roller 159c is rotationally driven and thus the intermediate transfer belt 158 is moved clockwise in an endless manner. The yellow toner image, the magenta toner image, the cyan toner image and the black toner image developed on the image bearing member 156 enter into an intermediate transfer nip where the image bearing member 156 and the intermediate transfer belt 158 meet. While these images are affected by the bias of the intermediate transfer bias roller 157, these images are intermediately transferred and overlapped atop on the intermediate transfer belt 158 to form a four color overlapped toner image.

The intermediate transfer system, which overlaps toner images using an intermediate transfer body such as an endless belt in such a manner that each single color toner image is formed on an image bearing member by a development device, the single color toner images are primarily transferred atop in a sequential manner on an intermediate transfer body by a transfer device and the obtained primarily transferred image is secondarily transferred to a recording medium at one time, can relatively easily and correctly determine the relative position of an image bearing member and an intermediate transfer body and is advantageous for color shifting. Therefore, the intermediate transfer system is good to produce quality images in full color.

The toner remaining on the surface of the image bearing member 156 which has passed the intermediate transfer nip as the image bearing rotates is removed by a drum cleaning unit 155. This drum cleaning unit 155 is to remove the residual toner remaining on the image bearing member 156 by a cleaning roller to which a cleaning bias is applied. Also, a cleaning brush having a cleaning brush formed of a fur brush, a magfur brush, etc., or a cleaning blade can be used.

Since the residual toner remaining on the image bearing member 156 is removed by the cleaning device, quality images can be formed in the next image formation cycle without bad charging and bad formation of latent images by irradiation. In addition, in the toner of the present invention, wax suitably oozes therein so that the toner is stably removed without a blade.

The surface of the image bearing member 156 which has been cleared of the residual toner is discharged by a discharging lamp 154. Specific examples of the discharging lamp 154 include, but are not limited to, a fluorescent lamp, a tungsten lamp, a halogen lamp, a mercury lamp, a sodium lamp, a light emitting diode (LED), a semi-conductor laser (LD), and electroluminescence (EL). A semi-conductor laser is used as the light source of the optical laser device mentioned above. To irradiate an image bearing member with only a light having a wavelength in a desired range, it is possible to use various kinds of filters, for example, sharp-cut filters, band pass filters, near-infrared cut filters, dichroic filters, interference filters, and color conversion filters.

Below the intermediate transfer unit 159 in FIG. 1, a transfer unit is provided which includes a transfer belt and various kinds of rollers such as a transfer bias roller and a driving roller. To the left hand side of this transfer unit, there are provided a transfer belt 164 and a fixing unit 165. In the transfer unit, an endless transfer belt can be moved in the up and down direction in FIG. 1 by a moving device (not shown) and at least the endless transfer belt retracts to a position where the endless transfer belt does not contact the intermediate transfer belt 158 when a single color toner image (i.e., yellow toner image), a two color overlapped toner image or a three color overlapped toner image passes the position at which a transfer bias roller 163 faces the intermediate transfer belt 158. The endless transfer belt moves to the position at which a transfer bias roller 163 faces the intermediate transfer belt 158 for forming a secondary transfer nip before the front end of a four color overlapped toner image enters into the position.

A pair of registration rollers 161 which nip a recording medium (transfer medium) 160 sent from a paper feeder (not shown) between the two rollers feed the recording medium 160 to the secondary transfer nip in synchronization with the four color toner overlapped toner image on the intermediate transfer belt 158. The four color overlapped toner image on the intermediate transfer device 158 is secondarily transferred to the recording medium 160 at one time by the secondary transfer bias of the transfer bias roller 163 in the secondary transfer nip. By this secondary transfer, a full color toner image is formed on the recording medium 160.

The recording medium 160 on which the full color toner image is formed is sent to the feeder belt 164 by a transfer belt 162. The feeder belt 164 sends the recording medium 160 received from the transfer unit into the fixing device 165. The fixing belt 165 illustrated in FIG. 1 is a roller system equipped with a heating device but can be a belt system equipped therewith.

The fixing device 165 of FIG. 1 transfers the recording medium 160 while nipping the recording medium 160 in the fixing nip formed by the contact between a heating roller and a backup roller. The full color toner image on the recording medium 160 is fixed thereon upon the heat from the heating roller and the pressure in the fixing nip. Oil free fixing can be done when the toner of the present invention is used.

Although it is not shown in FIG. 1, a bias is applied to the transfer belt 162 and the feeder belt 164 to attract the recording medium 160. In addition, there are provided a recording medium discharging device for discharging the recording medium 160 and a belt discharging device for discharging each belt of the intermediate transfer belt 158, the transfer belt 162 and the feeder belt 164. In the intermediate transfer unit, there is provided a belt cleaning unit having the same structure as that of the drum cleaning unit 155. By this belt cleaning unit, the residual toner remaining on the intermediate transfer belt 158 is removed.

### Process Cartridge

The process cartridge of the present invention integrally includes an image bearing member, a development device and at least one device selected from the group consisting of a charging device, a latent electrostatic image formation device (irradiation device), a transfer device, and a cleaning device and is designed to be detachably attached to the main body of an image forming apparatus. The process cartridge can optionally include other devices. The development device accommodates the toner of the present invention. That is, the development device includes at least a developing agent container (toner container) accommodating the toner.

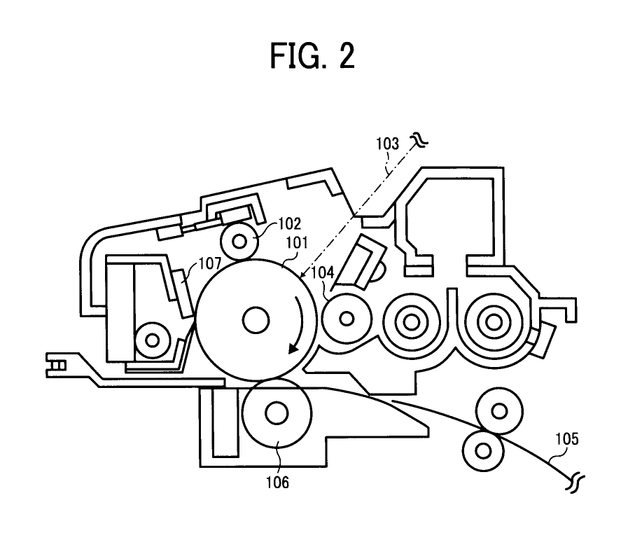

The process cartridge includes, for example, an image bearing member 101, a charging device 102, an irradiation device 103, a development device 104, and a cleaning device 107 as illustrated in FIG. 2, and can optionally has other devices. In FIG. 2, 105 represents a recording medium (transfer medium) and 106 represents a transfer device.

Since a form of a process cartridge is adopted, it is possible to replace an image bearing member and other processing devices in a short time with ease. Meaning that the time and cost to be taken for maintenance are reduced. Furthermore, since the processing devices and the image bearing member are integrally united, there are advantages such that the accuracy with regard to the relative positions thereof can be improved.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Polyesters, prepolymers, master batches, liquid dispersions of a laminate compound A having a negative charging property and liquid dispersions of a laminate compound B having a positive charging property are prepared or synthesized as follows.

### Synthesis of Polyester

The following components are placed in a reaction container equipped with a condenser, stirrer and a nitrogen introducing tube to conduct a reaction at 230° C. for 8 hours under normal pressure followed by another reaction with a reduced pressure of 10 to 15 mmHg for 5 hours:

| | |
|---|---|
| Adduct of bisphenol A with 2 mol of ethylene oxide | 553 parts |
| Bisphenol A with 2 mole of propylene oxide | 196 parts |
| Terephthalic acid | 220 parts |
| Adipic acid | 45 parts |
| Dibutyl tin oxide | 2 parts |

Forty six (46 ) parts of trimellitic anhydride is added in the reaction container to conduct a reaction at 180° C. under normal pressure for 2 hours and thus Polyester 1 is obtained.

The obtained Polyester 1 has a number average molecular weight of 2,200, a weight average molecular weight of 5,600, a glass transition temperature of 43° C. and an acid value of 13 mgKOH/g.

### Synthesis of Prepolymer

The following components are placed in a reaction container equipped with a condenser, stirrer and a nitrogen introducing tube to conduct a reaction at 230° C. for 8 hours under normal pressure followed by another reaction with a reduced pressure of 10 to 15 mmHg for 5 hours:

| | | |
|---|---|---|
| Adduct of bisphenol A with 2 mol of ethylene oxide | 682 | parts |
| Bisphenol A with 2 mole of propylene oxide | 81 | parts |
| Terephthalic acid | 283 | parts |
| Trimellitic anhydride | 22 | parts |
| Dibutyl tin oxide | 2 | parts |

Thus, Intermediate polyester 1 is obtained.

The obtained Intermediate polyester 1 has a number average molecular weight of 2,100, a weight average molecular weight of 9,500, a glass transition temperature of 55° C., an acid value of 0.5 mgKOH/g and a hydroxyl value of 49 mgKOH/g.

Next, 411 parts of Intermediate polyester 1, 89 parts of isophorone diisocyanate and 500 parts of ethyl acetate are placed in a reaction container equipped with a condenser, stirrer and a nitrogen introducing tube to conduct reaction at 100° C. for 5 hours to obtain Prepolymer 1. The weight % of isolated isocyanate of the obtained Prepolymer 1 is 1.53%.

### Synthesis of Master Batch

40 parts of carbon black (REGUL 400R, manufactured by Cabot Corporation), 60 parts of binder resin (polyester resin) (RS-801, manufactured by Sanyo Chemical Industries, Ltd., Acid value: 10, Mw: 20,000, Tg: 64° C.) and 30 parts of water are mixed by a HENSCHEL MIXER to obtain a mixture in which water sops in a pigment agglomeration body. The mixture is mixed and kneaded for 45 minutes by two rolls in which the temperature of the surface of the roll is set at 130° C. and pulverized by a pulverizer to the size of 1 mm φ. Thus, Master batch 1 is obtained.

### Preparation of Liquid Dispersion of Laminate Compound A Having Negative Charging Property

As a laminate compound A having a negative charging property modified by an organic cation, organic cation modified clay {APA (a monmolinite laminate mineral deionized by quaternary ammonium ion (cation): CRAYTONE APA, manufactured by Southern Clay Product Inc.) is used and a liquid dispersion thereof is prescribed as follows:

10 parts of APA, 30 parts of Polyester 1, 60 parts of ethyl acetate are placed in and mixed by a TK HOMOMIXER (manufactured by Tokushu Kika Kogyo Co., Ltd.) while adjusting the rotation number thereof from 8,000 to 13,000 rpm for 10 minutes. Laminate compound liquid dispersion A1 (APA 1) having a dispersion particle diameter of 0.6 μm is obtained. Laminate compound liquid dispersion A2 having a dispersion particle diameter of 0.18 μm is prepared in the same manner as in Laminate compound liquid dispersion A1 except that the mixing time is changed to 30 minutes.

### Preparation of Liquid Dispersion of Laminate Compound B A Having Positive Charging Property

As a laminate compound B having a positive charging property modified by an organic anion, organic anion modified hydrotalcite, which is a hydrotalcite laminate mineral in which a long chain aliphatic acid ion (anion) is intercalated into between layers of hydrotalcite, is synthesized by the following method.

10 parts of an organic anion modified hydrotalcite, 30 parts of Polyester 1, 60 parts of ethyl acetate are placed in and mixed by a TK HOMOMIXER (manufactured by Tokushu Kika Kogyo Co., Ltd.) at a rotation number of 8,000 to 13,000 rpm for 40 minutes. Laminate compound liquid dispersion B1 (Organic anion modified hydrotalcite 1) having a dispersion particle diameter of 0.13 μm is obtained. Laminate compound liquid dispersion B2 (Organic anion modified hydrotalcite 2) having a dispersion particle diameter of 0.6 μm is prepared in the same manner as in Laminate compound liquid dispersion B1 except that the mixing time is changed to 10 minutes.

Manufacturing of Laminate Inorganic Mineral in which Aliphatic Acid is Intercalated

1,200 parts of water, 1,550 parts of hydrotalcite and 15 parts of stearic acid are mixed by a HENSCEL MIXER (manufactured by Mitsui Mining Co., Ltd.). A laminate inorganic mineral in which an aliphatic acid is intercalated is prepared by a flashing method in which the mixture (an aqueous paste containing hydrotalcite and stearic acid) is mixed and kneaded by a kneader at 150° C. for 60 minutes to transfer the stearic acid to between the layers of the hydrotalcite followed by removing the water. To the thus obtained laminate inorganic mineral in which an aliphatic acid is intercalated, 15 parts of methoxy trimethylsilane is added and the mixture is mixed and kneaded by the kneader to obtain Laminate inorganic mineral in which an aliphatic acid is intercalated 1. The thus obtained Laminate inorganic mineral in which an aliphatic acid is intercalated 1 is placed in a medium formed of ethyl acetate and water in an amount ratio of 1:1 followed by concussion. After the resultant is left for one hour, the laminate inorganic mineral in which an aliphatic acid is intercalated is confirmed to be existent at the interface between ethyl acetate and water.

### Example 1

Developing agent 1 of the present invention is obtained as follows:

The following is placed and mixed in a reaction container equipped with a stirrer and a thermometer:

| | |
|---|---|
| Polyester 1 | 378 parts |
| Paraffin wax (HNP9) | 120 parts |
| Ethyl acetate | 1,450 parts |

The mixture is agitated and heated to 80° C., kept at 80° C. for 5 hours and then cooled down to 30° C. in 1 hour. 500 parts of Master batch 1 and 500 parts of ethyl acetate are placed in the reaction container followed by one hour mixing to obtain Liquid material 1.

1,500 parts of Liquid material 1 is transferred to another container and carbon black and wax are dispersed using a bead mill (ULTRAVISCOMILL from AIMEX) under the following conditions:

Liquid feeding speed: 1 kg/hr,

Disc rotation perimeter speed: 6 m/sec

Diameter of zirconia beads: 0.5 mm

Filling factor of zirconia beads: 80% by volume

Repeat number of dispersion treatment: 3 times

655 parts of 65% ethylacetate of Polyester 1 is added thereto followed by dispersion by the bead mill under the conditions described above for one pass. Pigment and wax liquid dispersion 1 is thus obtained. Ethyl acetate is added for adjustment such that the solid density (130° C., 30 minutes) of Pigment and wax liquid dispersion 1 is 50%.

### Preparation of Aqueous Phase

953 parts of deionized water, 88 parts of 25% by weight an aqueous liquid dispersion of organic resin particulates (a copolymer of styrene−methactylic acid−butyl acrylate−a sodium salt of sulfate of an adduct of methacrylic acid with ethyleneoxide) for stabilizing dispersion, 90 parts of 48.5% aqueous solution of sodium dodecyldiphenyl etherdisulfonate (EREMINOR MON-7, manufactured by Sanyo Chemical Industries, Ltd.), and 113 parts of ethyl acetate. Thus, a milk white liquid (Aqueous phase 1) is obtained.

### Emulsification

As shown in Table 1, to 967 parts of Pigment and wax liquid dispersion 1, 1.0% (Conversion of toner solid portion) Laminate compound liquid dispersion A1 (APA 1) and 1.0% (Conversion of toner solid portion) Laminate compound liquid dispersion B1 (Organic anion modified hydrotalcite 1) are added with 6 parts of isophhorone dimaine as an amine. The mixture is mixed by a TK HOMOMIXER (manufactured by Tokushu Kika Kogyo Co., Ltd.) at a rotation number of 5,000 rpm for one minute. Thereafter, 137 parts of Prepolymer 1 is admixed by the TK HOMOMIXER (manufactured by Tokushu Kika Kogyo Co., Ltd.) at a rotation number of 5,000 rpm for one minute. Then, 1,200 parts of Aqueous phase 1 is added and the resultant is mixed by the TK HOMOMIXER (manufactured by Tokushu Kika Kogyo Co., Ltd.) while controlling the rotation speed thereof in the range of from 8,000 to 13,000 rpm for 20 minutes to obtain Emulsion slurry 1.

### Removal of Solvent

Emulsion slurry 1 is placed in a container equipped with a stirrer and a thermometer and the solvent is removed at 30° C. for 8 hours to obtain Dispersed slurry 1.

### Washing and Drying

After 100 parts of Dispersion slurry 1 is filtered with a reduced pressure;
(I): 100 parts of deionized water is added to the filtered cake and the mixture is mixed by a TK HOMOMIXER at a rotation number of 12,000 rpm for 10 minutes;
(II): 900 parts of deionized water is added to the filtered cake of (I) and the resultant is mixed by a TK HOMOMIXER at a rotation number of 12,000 rpm for 30 minutes while applying ultrasonic vibration thereto, and then filtered under a reduced pressure. This operation is repeated until the electric conductivity of the slurry liquid is not greater than 10 μC/cm;
(III): 10% hydrochloric acid is added to the slurry liquid of (II) to make pH of the slurry liquid to be 4 followed by 30 minute stirring by a three one motor; and
(IV): 10 parts of deionized water is added to the filtered cake of (III) and the resultant is mixed by a TK HOMOMIXER at a rotation number of 12,000 rpm for 10 minutes followed by filtration. This operation is repeated until the electric conductivity of the slurry liquid is not greater than 10 μC/cm. Thus, Filtered cake 1 is obtained.

Filtered cake 1 is dried by a circulating drier at 45° C. for 48 hours. The dried cake is sieved using a screen having openings of 75 μm to obtain Mother toner 1. Mother toner 1 has a volume average particle diameter (Dv) of 5.8 μm, a number average particle diameter (DP) of 5.2 μm, Dv/Dp of 1.12 and an average circularity of 0.973. Then, 100 parts of hydrophobic silica and 0.5 parts of hydrophobized titan oxide are mixed with Mother toner 1 by a HENSCHEL MIXER. Developing agent 1 of the present invention is thus prepared.

The average dispersion particle diameters (weight average particle diameters) of Laminate compound A and Laminate compound B and the number average particle diameter and the average circularity of the toner of Developing agent 1 are shown in Table 1.

### Examples 2 to 5

Developing agents 2 to 5 of the present invention are prepared in the same manner as in Example 1 except that the kind and the addition amount of APA 1 and Organic anion modified hydrotalcite 1 are changed as shown in Table 1.

The particle diameters of Laminate compound As and Laminate compound Bs and the number average particle diameters and the average circularities of the toners of Developing agents 2 to 5 are shown in Table 1.

### Comparative Example 1

Comparative developing agent 1 is prepared in the same manner as in Example 1 except that both APA 1 and Organic anion modified hydrotalcite 1 are not used.

The number average particle diameter and the average circularity of the toner in Comparative developing agent 1 are shown in Table 1.

### Comparative Example 2

Comparative developing agent 2 is prepared in the same manner as in Example 1 except that APA 1 is not used.

The weight average particle diameter of Laminate compound B and the number average particle diameter and the average circularity of the toner in Comparative developing agent 2 are shown in Table 1.

### Comparative Examples 3 and 4

Comparative developing agents 3 and 4 are prepared in the same manner as in Example 1 except that the kind and the addition amount of APA 1 and Organic anion modified hydrotalcite 1 are changed as shown in Table 1.

The weight average particle diameters of laminate compound As and Laminate compound Bs and the number average particle diameters and the average circularities of the toners in Comparative developing agents 3 and 4 are shown in Table 1.

The developing agents prepared in Examples 1 to 5 and Comparative Examples 1 to 4 are evaluated on the fixing property (background fouling, density, transferability, stress resistance and fixing separation property) under the following conditions.

### Evaluation Method

### Fixing Separation Evaluation

Unfixed images having a solid band image (the amount of attachment: 9 g/m²) having a width of 36 mm are produced on the front end having a width of 3 mm of A4 with portrait direction using IPSiO NX60s (manufactured by Ricoh Co., Ltd.) with the developing agent (toner) to which externally additives are added.

These unfixed images are fixed by a fixing device in the temperature range of from 130 to 190° C. with an interval of 10° C. to obtain the temperature range for separable fixing and non-offset. This temperature range represents a range in which a sheet can be suitably separated from a heating roller without offset phenomena and the image is not easily detached or peeled. Paper (45 g/m²) and the direction (machine direction is perpendicular to paper running direction: portrait) of paper are selected in light of disadvantageous conditions for fixing. The perimeter speed of the fixing device is 120 mm/sec.

### Fixing Separation Evaluation Criteria

G: Separable/non-offset temperature range is greater than 50° C.
F: Separable/non-offset temperature range is wider than 30° C. and not greater than 50° C.
B: Separable/non-offset temperature range is not greater than 30° C.

### Evaluation on Transferability

Images having a predetermined pattern with a B/W ratio of 6% are continuously printed in the environment (N/N) of 23° C. and 45% using IPSiO NX60s (manufactured by Ricoh Co., Ltd.) and the developing agent (toner) to which externally additives are added. After a continuous printing of 2,000 images under the environment (N/N), toner on the image bearing member during printing of a solid image having a predetermined area is suctioned and the weight of the toner is measured. Also, toner on paper before fixing is suctioned and the weight of the toner is measured to obtain the transfer efficiency.

### Evaluation Criteria of Transferability (Transfer Efficiency)

G: 85% or more
F: 75% to less than 85%
B: less than 75%

### Evaluation on Stress Resistance, Density and Background Fouling

Images having a predetermined pattern with a B/W ratio of 6% are continuously printed in the environment (N/N) of 23° C. and 45% using IPSiO NX60s (manufactured by Ricoh Co., Ltd.) and the developing agent (toner) to which externally additives are added. After a continuous printing of 50 and 2,000 images under the environment (N/N), toner on the development roller during printing of a white image pattern is suctioned. The amount of charge is measured by an electrometer to evaluate the difference between the amount of charge after 50 images and that after 2,000 images. With regard to the evaluation on the density, the printing sample after 2,000 images are printed is observed with naked eyes. With regard to the evaluation on the background fouling on the image bearing member, the density of the toner on the image bearing member is evaluated by observing a transparent adhesive tape with naked eyes which is attached to white paper after the adhesive tape is attached to and detached from the developed and uncleaned portion on the image bearing member.

Evaluation Criteria on Image Density and Background Fouling Observed with Naked Eyes and Background Fouling
G: Good
F: No practical problem
B: No good at practical level

### Evaluation Criteria on Stress Resistance

G: Difference of the amount of charge in absolute value is less than 10 μC/g
F: Difference of the amount of charge in absolute value is from 10 to 15 μC/g
B: Difference of the amount of charge in absolute value is greater than 15 μC/g

TABLE 1

| | | | | | | | | Toner | |
|---|---|---|---|---|---|---|---|---|---|
| | Charge control agent A | | | Charge control agent B | | | | Characteristics | |
| | | Weight | | | Weight | | | Number | |
| | | average | | | average | | | average | |
| | | particle | Addition | | particle | Addition | | particle | |
| | | diameter | amount | | diameter | amount | Value | diameter | |
| | Kind | (Da) (μm) | (%) | Kind | (Db) (μm) | (%) | of (A) | (μm) | Circularity |
| Example 1 | APA 1 | 0.60 | 1.0 | N5P1 | 0.13 | 1.0 | 0.36 | 7.5 | 0.972 |
| Example 2 | APA 1 | 0.60 | 3.0 | N5P1 | 0.13 | 1.0 | 0.55 | 7.3 | 0.954 |
| Example 3 | APA 1 | 0.60 | 1.0 | N5P1 | 0.13 | 3.0 | 0.04 | 7.2 | 0.961 |
| Example 4 | APA 2 | 0.18 | 1.0 | N5P1 | 0.13 | 2.0 | 0.51 | 7.2 | 0.975 |
| Example 5 | APA 1 | 0.60 | 1.0 | N5P2 | 0.60 | 2.0 | 0.72 | 7.4 | 0.948 |
| Comparative | — | — | — | — | — | — | — | 7.3 | 0.982 |
| Example 1 | | | | | | | | | |
| Comparative | — | — | — | N5P1 | 0.13 | 3.0 | 1.00 | 7.3 | 0.966 |
| Example 2 | | | | | | | | | |
| Comparative | APA 2 | 0.18 | 1.0 | N5P1 | 0.13 | 1.0 | 2.30 | 7.0 | 0.977 |
| Example 3 | | | | | | | | | |
| Comparative | APA 1 | 0.60 | 1.0 | N5P2 | 0.60 | 1.0 | 1.20 | 7.4 | 0.932 |
| Example 4 | | | | | | | | | |

| | Evaluation result | | | | |
|---|---|---|---|---|---|
| | | | | | Fixing |
| | Background | | | Stress | separation |
| | fouling | Density | Transferability | resistance | property |
| Example 1 | F | G | G | G | G |
| Example 2 | G | G | F | F | G |
| Example 3 | G | G | G | G | G |
| Example 4 | F | G | G | G | G |
| Example 5 | F | G | F | F | G |
| Comparative | B | F | B | G | G |
| Example 1 | | | | | |
| Comparative | B | G | F | G | G |
| Example 2 | | | | | |
| Comparative | B | B | B | F | G |
| Example 3 | | | | | |
| Comparative | G | F | B | F | G |
| Example 4 | | | | | |

(A) = [Si/(Al + Mg + Si)] (1)/[Si/(Al + Mg + Si)] (2)

As seen in the evaluation results in Table 1, the developing agents of Examples 1 to 5 have generally excellent results in electrophotograpic processes. However, the results of the developing agents of Comparative Examples 1 to 4, are not satisfactory with regard to at least one of the density, transferability, and stress resistance evaluation.

That is, an image forming apparatus using the toner of the present invention can form high definition images without background fouling since the toner of the present invention has a positive charging property on the surface portion of a particle and a negative charging property at the inside thereof by the composite structure of laminate compound A and laminate compound B so that the toner has a good combination of the low temperature fixability and the heat resistance and good offset resistance and keeps a sufficient amount of chargeability without contaminating devices for development over a long period of use.

This document claims priority and contains subject matter related to Japanese Patent Application No. 2007-071438, filed on Mar. 19, 2007, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising:
particles comprising a toner composition, the toner composition comprising a binder resin and a coloring material,
wherein the toner composition comprises a laminate compound A in which a cation between layers is modified by an organic cation, and a laminate compound B in which an anion between layers is modified by an organic anion, the laminate compound A is of negative charging property upon particulation of the laminate compound A by dispersion or internal addition in the binder resin and the laminate compound B is of positive charging property upon particulation of the laminate compound B by dispersion or internal addition in the binder resin, and the toner is of a positive charging property.

2. The toner according to claim 1, wherein the laminate compound B is more abundant at a surface of the particle than the laminate compound A such that that the surface of the particle is of positive charging property.

3. The toner according to claim 1, wherein the toner has been granulated by emulsifying or dispersing an oil phase comprising the binder resin and/or a precursor thereof, the coloring material, the laminate compound A and the laminate compound B in an aqueous medium.

4. The toner according to claim 1, wherein the laminate compound A comprises Si and Al and the laminate compound B comprises Al and Mg.

5. The toner according to claim 4, the toner satisfies the following relationship:
[Si/(Al+Mg+Si)](1)/[Si/(Al+Mg+Si)](2)<1,
wherein [Si/(Al+Mg+Si)](2) is an elemental analysis ratio for an entire bulk detected by a fluorescent X ray analysis, and [Si/(Al+Mg+Si)](1) is an elemental analysis ratio for a surface bulk detected by an XPS analysis.

6. The toner according to claim 1, wherein the binder resin comprises a polyester resin having a glass transition temperature of from 40 to 80° C.

7. The toner according to claim 1, wherein the binder resin comprises a modified polyester resin.

8. The toner according to claim 7, wherein the modified polyester resin comprises at least one of a urea group and a urethane group.

9. The toner according to claim 7, wherein the modified polyester resin is a resin prepared by conducting a reaction of a polyester resin having an isocyanate group at an end thereof and an amine.

10. The toner according to claim 1, wherein the toner is a non-magnetic one component toner having a positive charging property.

11. An image forming apparatus comprising:
an image bearing member configured to bear a latent electrostatic image thereon;
a charging member configured to charge the image bearing member;
an irradiation device configured to irradiate a surface of the image bearing member to form the latent electrostatic image thereon;
a development device comprising the toner of claim 1 and configured to develop the latent electrostatic image;
a transfer device configured to transfer the developed image to a transfer medium; and
a fixing member configured to fix the transferred image on the transfer medium.

12. The image forming apparatus according to claim 11, wherein the transfer device comprises an intermediate transfer device comprising an endless form.

13. The image forming apparatus according to claim 12, further comprising a cleaning device configured to remove residual toner remaining on at least one of the image bearing member and the intermediate transfer device.

14. The image forming apparatus according to claim 13, wherein a blade is provided to the cleaning device.

15. The image forming apparatus according to claim 11, wherein the fixing device is a roller comprising a heating device.

16. The image forming apparatus according to claim 11, wherein the fixing device is a belt comprising a heating device.

17. The image forming apparatus according to claim 11, wherein the fixing device is an oil-free fixing device which dispenses with oil application for the fixing device.

18. A process cartridge comprising:
an image bearing member configured to bear a latent electrostatic image thereon;
a development device comprising the toner of claim 1 and configured to develop the latent electrostatic image; and
at least one device selected from the group consisting of a charging member configured to charge the image bearing member, an irradiation device configured to irradiate a surface of the image bearing member to form the latent electrostatic image thereon, a transfer device configured to transfer the developed image to a transfer medium and a cleaning device configured to remove residual toner remaining on at least one of the image bearing member and the intermediate transfer device,
wherein the process cartridge is detachably attached to an image bearing member.
